(19) United States
(12) Patent Application Publication
(10) Pub. No.: US 2009/0027138 A1
(43) Pub. Date: Jan. 29, 2009

(54) Switch Circuit

(76) Inventors: Tamotsu Nishino, Tokyo (JP); Masatake Hangai, Tokyo (JP); Yukihisa Yoshida, Tokyo (JP); Shinichi Izuo, Tokyo (JP); Hirokazu Taketomi, Tokyo (JP); Tomohiro Takahashi, Tokyo (JP); Kenichiro Kodama, Tokyo (JP); Kazushi Nishizawa, Tokyo (JP); Yoko Koga, Tokyo (JP); Araki Ohno, Tokyo (JP); Shinnosuke Soda, Tokyo (JP); Moriyasu Miyazaki, Tokyo (JP); Kenichi Miyaguchi, Tokyo (JP)

Correspondence Address: BIRCH STEWART KOLASCH & BIRCH, PO BOX 747, FALLS CHURCH, VA, 22040-0747, US

(21) Appl. No.: 11/886,589

(22) PCT Filed: Mar. 29, 2005
(86) PCT No.: PCT/JP2005/005900

§ 371 Date: Sep. 18, 2007

(51) Int. Cl. H01P 1/10

(52) U.S. Cl. 333/103

(57) ABSTRACT

A switch circuit including: a plurality of MEMS switches connected in parallel or in series, which have different drive voltages; and a single voltage supply for driving the plurality of MEMS switches by the plurality of drive voltages, is used for a microwave circuit or an antenna circuit, to vary a configuration of the microwave circuit or the antenna circuit based on the drive voltage value. That is, the configuration of the microwave circuit or the antenna circuit can be varied based on the drive voltage value by using the switch circuit including the MEMS switches having the different drive voltages for the microwave circuit or the antenna circuit.

### TECHNICAL FIELD

The present invention relates to a switch circuit constituted by a plurality of microelectromechanical systems (MEMS) switches having different drive voltages, which is employed in a microwave circuit or an antenna circuit, and for varying configuration of the microwave circuit or the antenna circuit based upon drive voltages.

### BACKGROUND ART

Referring now to FIG. 5, a conventional microwave circuit will be described. FIG. 5 is a diagram for showing a configuration of the conventional microwave circuit (refer to, for instance, Non-patent Document 1).

In FIG. 5, the conventional microwave circuit is provided with Lange coupler 503 to which an input terminal 501 and an output terminal 502 are connected, and a signal circuit which is connected to coupling terminals 506 and 507 of the Lange coupler 503.

To the Lange coupler 503, an input terminal 504 connected to the input terminal 501 of the microwave circuit, an output terminal 505 connected to the output terminal 502 of the microwave circuit, the coupling terminal 506, and the coupling terminal 507 are connected.

The signal circuit is provided with: a line 511, one end of which is connected to the coupling terminal 506, and another end of which is connected to a ground 513; a line 512, one end of which is connected to the coupling terminal 507, and another end of which is connected to a ground 514; MEMS switches 521, 525, and 529, which are connected to a midst of the line 511 in this order from a closer side with respect to the coupling terminal 506; MEMS switches 522, 526, and 530, which are connected to a midst of the line 512 in this order from closer with respect to the coupling terminal 507; a bias terminal 551, which is connected to the MEMS switch 521 and also to the MEMS switch 522; a bias terminal 552, which is connected to the MEMS switch 525 and also to the MEMS switch 526; and a bias terminal 553, which is connected to the MEMS switch 529 and also to the MEMS switch 530.

Next, operations of the conventional microwave circuit will now be described with reference to the figure. It should be noted that, as to lengths, a relationship of 0<L1<L2<L3<L4 is established.

FIG. 5 shows a circuit for a 2-bit phase shifter within a 4-bit phase shifter. The Lange coupler 503 outputs a half portion of a radio frequency signal entered from the input terminal 504 to the coupling terminal 506, and outputs the remaining half portion thereof to the coupling terminal 507. A phase of the signal outputted from the coupling terminal 507 is delayed by 90 degrees with respect to a phase of the signal outputted from the coupling terminal 506.

The radio frequency signal outputted to the coupling terminal 506 is reflected by the MEMS switch 521, the MEMS switch 525, the MEMS switch 529, or the ground 513 being an end, passes again through the coupling terminal 506, and then a half signal portion thereof is outputted to the input terminal 504 and the remaining half portion thereof is outputted to the output terminal 505. In this case, a phase of the signal outputted from the output terminal 505 is delayed by 90 degrees with respect to a phase of the signal outputted from the input terminal 504.

Similarly, the radio frequency signal outputted to the coupling terminal 507 is reflected by the MEMS switch 522, the MEMS switch 526, the MEMS switch 530, or the ground 514 being an end, passes again through the coupling 507, and then a half portion thereof is outputted to the input terminal 504, and the remaining half portion thereof is outputted to the output terminal 505. In this case, a phase of the signal outputted from the input terminal 504 is delayed by 90 degrees with respect to a phase of the signal outputted from the output terminal 505.

If a voltage is applied to the bias terminal 551, the MEMS switches 521 and 522 shortcircuit the lines 511 and 512 just at positions of the MEMS switches 521 and 522. The reflection waves reflected by the respective lines 511 and 512 are reflected based upon same reflection phases “Γ”. As a result, there is no phase difference between a signal which is propagated from the input terminal 501 through the input terminal 504, the coupling terminal 506, the MEMS switch 521, the coupling terminal 506, the output terminal 505, and the output terminal 502 in this order, and another signal which is propagated from the input terminal 501 through the input terminal 504, the coupling terminal 507, the MEMS switch 522, the coupling terminal 507, the output terminal 505, and the output terminal 502 in this order. Thus, those signals are superimposed with each other.

On the other hand, a phase of a signal which is propagated from the input terminal 501 through the input terminal 504, the coupling terminal 506, the MEMS switch 521, the coupling terminal 506, the input terminal 504, and the input terminal 501 in this order, is opposite to a phase of another signal which is propagated from the input terminal 501 through the input terminal 504, the coupling terminal 507, the MEMS switch 522, the coupling terminal 507, the input terminal 504, and the input terminal 501 in this order. Thus, those signals are canceled with each other.

As previously described, as long as the radio frequency signals entered from the input terminal 501 are reflected at the same positions on the lines 511 and 512, all of those radio frequency signals are outputted to the output terminal 502, while those output signals have constant phase delays. The phase delay amounts can be generated based on the selection of the below-mentioned four manners. That is, a voltage is applied to anyone of the bias terminal 551, the bias terminal 552, and the bias terminal 553. Alternatively, the voltage is not applied to any of those bias terminals 551 to 553.

When no voltage is applied to any of the bias terminals 551 to 553, a length of each of the lines 511 and 512 is equivalent to “L4”, and a phase delay corresponds to a distance in which a radio signal is propagated, two times longer than the length “L4”.

When a voltage is applied to the bias terminal 553, a length of each of the lines 511 and 512 is equivalent to “L3”, and a phase delay corresponds to a distance in which a radio signal is propagated two times longer than the length “L3”.

When a voltage is applied to the bias terminal 552, a length of each of the lines 511 and 512 is equivalent to “L2”, and a phase delay corresponds to a distance in which a radio signal is propagated two times longer than the length “L2”.

When a voltage is applied to the bias terminal 551, a length of each of the lines 511 and 512 is equivalent to “L1”, and a phase delay corresponds to a distance in which a radio signal is propagated two times longer than the length “L1”. As a result, the above-mentioned circuit may be referred to as a phase shifter circuit for 2 bits, but requires at least three bias terminals 551 to 553.

Non-patent Document 1: A. Malczewski, S. Eshelman, B. Pillans, J. Ehmke, and C. L. Goldsmith “X-Band RF MEMS Phase Shifters for Phased Array Applications”, IEEE MICROWAVE AND GUIDED WAVE LETTERS, VOL. 9, NO. 12, DECEMBER 1999, pp. 517-519.

### DISCLOSURE OF THE INVENTION

### Problems to be Solved by the Invention

In the above-mentioned conventional microwave circuit, there is such a problem that at least three bias terminals are required.

The present invention has been made to solve the above-mentioned problem, and it is an object of the present invention to provide a switch circuit having bias terminals reduced in number, and being capable of readily changing a configuration of a circuit such as a microwave circuit or an antenna circuit.

### Means for Solving the Problems

A switch circuit according to the present invention includes: a plurality of MEMS switches which are connected parallel to each other, and whose drive voltages are different from each other; and a single voltage source for driving the plurality of MEMS switches based upon a plurality of drive voltages.

### EFFECTS OF THE INVENTION

According to the switch circuit of the present invention, bias terminals can be reduced in number and the configuration of a circuit such as the microwave circuit or the antenna circuit can be readily changed, which are advantageous.

### BRIEF DESCRIPTION OF THE DRAWINGS

FIG. 1 is a diagram for showing a configuration of a microwave circuit according to Embodiment 1 of the present invention.

FIG. 2 is a diagram for showing a relationship between voltages applied to bias terminals and lengths of lines up to the ground points of the microwave circuit according to Embodiment 1 of the present invention.

FIG. 3 is a diagram for showing a configuration of an antenna circuit according to Embodiment 2 of the present invention.

FIG. 4 is a diagram for showing a configuration of an antenna circuit according to Embodiment 3 of the present invention.

FIG. 5 is a diagram for showing a configuration of a conventional microwave circuit.

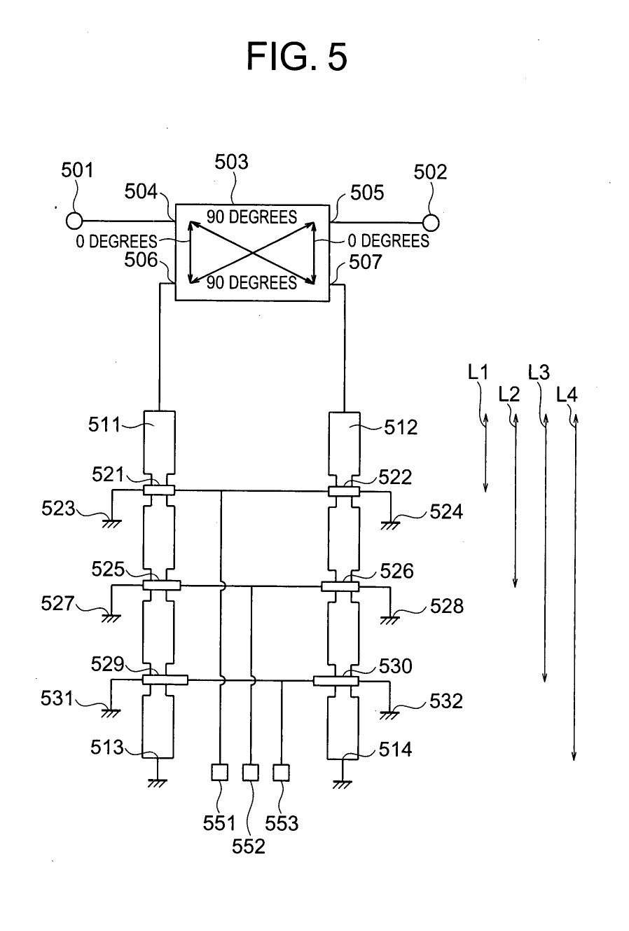

### BEST MODE FOR CARRYING OUT THE INVENTION

Embodiment 1 describes such an example that a switch circuit is employed in a microwave circuit, while the switch circuit is configured by a plurality of MEMS switches having different drive voltages from each other. Embodiments 2 and 3 describe another example in which the above-mentioned switch circuit is employed in an antenna circuit. It should be noted that a relationship between voltages (0<V1<V2<V3 . . . ) and lengths (0<L1<L2<L3<L4 . . . ) represents a relationship of relative magnitudes each of the embodiments. Accordingly, for example, the voltage “V1” of Embodiment 1 is not always equal to the voltage “V1” of Embodiment 2.

### EMBODIMENT 1

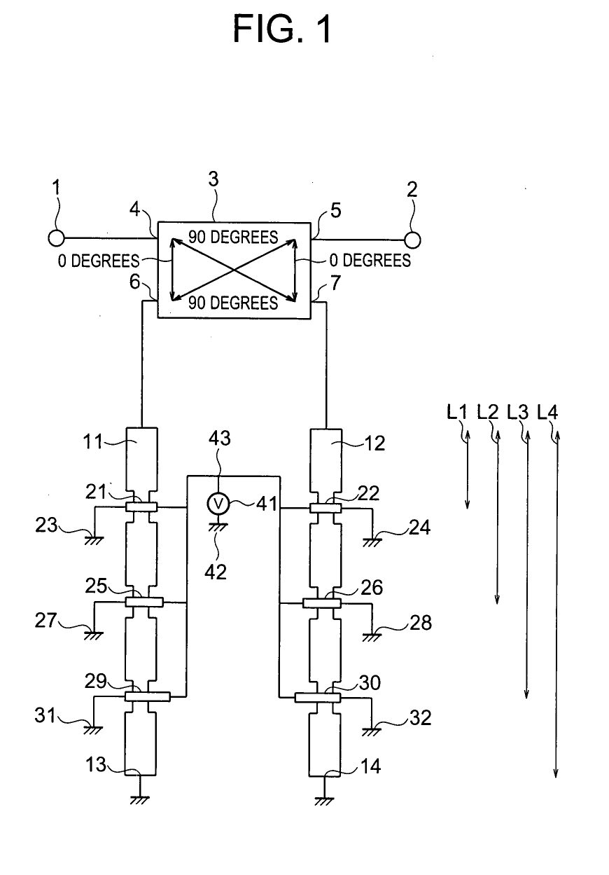

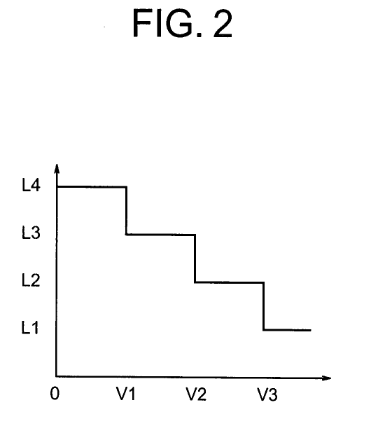

A microwave circuit according to Embodiment 1 of the present invention will now be described with reference to FIGS. 1 and 2. FIG. 1 is a diagram for showing a configuration of the microwave circuit according to Embodiment 1 of the present invention.

In FIG. 1, in the microwave circuit according to Embodiment 1, a 90-degree/3-dB coupler 3 and a signal circuit are provided. An input terminal 1 and an output terminal 2 are connected to the 90-degrees/3-dB coupler 3. The signal circuit is connected to coupling terminals 6 and 7 of the 90-degrees/3-dB coupler 3.

To the 90-degrees/3-dB coupler 3, an input terminal 4 connected to the input terminal 1 of the microwave circuit, an output terminal 5 connected to the output terminal 2 of the microwave circuit, the coupling terminal 6, and the coupling terminal 7 are connected.

The signal circuit is provided with: a line 11, one end of which is connected to the coupling terminal 6, and another end of which is connected to the ground 13; a line 12, one end of which is connected to the coupling terminal 7, and another end of which is connected to the ground 14; MEMS switches 21, 25, and 29, which are connected to a midst of the line 11 in this order from a closer side with respect to the coupling terminal 6; MEMS switches 22, 26, and 30, which are connected to a midst of the line 12 in this order from a closer side with respect to the coupling terminal 7; and a commonly-used voltage source 41, one end of which is connected via a bias terminal 43 to the MEMS switches 21, 22, 25, 26, 29, and 30, and another end of which is connected to the ground 42.

Next, operations of the microwave circuit according to Embodiment 1 will now be described with reference to the figure. FIG. 2 is a diagram for representing a relationship between voltages of bias terminals and lengths of lines up to the ground points of the microwave circuit according to Embodiment 1 of the present invention. It should be noted that, as to voltages, a relationship of 0 (volt)<V1<V2<V3 is established, and as to lengths, a relationship of 0<L1<L2<L3<L4 is established.

The 90-degrees/3-dB coupler 3 outputs a half signal portion of a radio frequency signal entered from the input terminal 4 to the coupling terminal 6, and outputs the remaining half signal portion thereof to the coupling terminal 7. A phase of the signal outputted from the coupling terminal 7 is delayed by 90 degrees with respect to a phase of the signal outputted from the coupling terminal 6.

The radio frequency signal outputted from the coupling terminal 6 is reflected by the MEMS switches 21, 25, and 29, or the ground 13 of a termination, and again passes through the coupling terminal 6, and then, a half signal portion thereof is outputted to the input terminal 4, and the remaining half signal portion thereof is outputted to the output terminal 5. In this case, a phase of the signal outputted from the output terminal 5 is delayed by 90 degrees with respect to a phase of the signal outputted from the input terminal 4.

Similarly, the radio frequency signal outputted from the coupling terminal 7 is reflected by the MEMS switches 22, 26, and 30, or the ground 14 of the termination, and again passes through the coupling terminal 7, and then, a half signal portion thereof is outputted to the input terminal 4, and the remaining half signal portion thereof is outputted to the output terminal 5. In this case, a phase of the signal outputted from the output terminal 5 is delayed by 90 degrees with respect to a phase of the signal outputted from the input terminal 4.

When a value of a voltage applied to the bias terminal 43 is “V3”, the MEMS switches 21 and 22 shortcircuit the lines 11 and 12 just at positions of the MEMS switches 21 and 22. The reflection waves reflected by the respective lines 11 and 12 are reflected based upon the same reflection phases “Γ”. As a result, there is no phase difference between a signal which is propagated from the input terminal 1 through the input terminal 4, the coupling terminal 6, the MEMS switch 21, the coupling terminal 6, the output terminal 5, and the output terminal 2 in this order, and a signal which is propagated from the input terminal 1 through the input terminal 4, the coupling terminal 7, the MEMS switch 22, the coupling terminal 7, the output terminal 5, and the output terminal 2 in this order. Thus, these signals are superimposed with each other.

On the other hand, a phase of a signal which is propagated from the input terminal 1 through the input terminal 4, the coupling terminal 6, the MEMS switch 21, the coupling terminal 6, the input terminal 4, and the input terminal 1 in this order, is opposite to a phase of a signal which is propagated from the input terminal 1 through the input terminal 4, the coupling terminal 7, the MEMS switch 22, the coupling terminal 7, the input terminal 4, and the input terminal 1 in this order, so these signals are canceled with each other.

As previously described, as long as the radio frequency signals entered from the input terminal 1 are reflected at the same positions of the lines 11 and 12, all of these radio frequency signals are outputted to the output terminal 2, while these output signals have constant phase delays. The phase delay amounts can be selected from the below-mentioned four manners. That is, the phase delay amounts can be selected from zero volt (0 V), V1, V2, and V3 of the voltages applied to the bias terminal 43.

When the voltage of the voltage source 41 is 0 V, as indicated in FIGS. 1 and 2, a length of the line 11 up to the ground point is “L4”.

When the voltage V1 is applied from the voltage source 41 to the bias terminal 43, the line 11 is connected to the ground 31 by the MEMS switch 29, and as represented in FIGS. 1 and 2, an equivalent length of the line 11 becomes “L3”.

When the voltage V2 is applied from the voltage source 41 to the bias terminal 43, the line 11 is connected to the ground by the MEMS switch 25, and as represented in FIGS. 1 and 2, an equivalent length of the line 11 becomes “L2”.

When the voltage V3 is applied from the voltage source 41 to the bias terminal 43, the line 11 is connected to the ground by the MEMS switch 21, and as represented in FIGS. 1 and 2, an equivalent length of the line 11 becomes “L1”.

When the voltage of the voltage source 41 is 0 V, as represented in FIGS. 1 and 2, a length of the line 12 up to the ground point is “L4”.

When the voltage V1 is applied from the voltage source to the bias terminal 43, the line 12 is connected to the ground 32 by the MEMS switch 30, and as represented in FIGS. 1 and 2, an equivalent length of the line 12 becomes “L3”.

When the voltage V2 is applied from the voltage source 41 to the bias terminal 43, the line 12 is connected to the ground 28 by the MEMS switch 26, and as represented in FIGS. 1 and 2, an equivalent length of the line 12 becomes “L2”.

When the voltage V3 is applied from the voltage source 41 to the bias terminal 43, the line 12 is connected to the ground 24 by the MEMS switch 22, and as represented in FIGS. 1 and 2, an equivalent length of the line 12 becomes “L1”. In this case, as described above, the voltage relationship is 0V<V1<V2<V3. As a result, only one bias terminal 43 is sufficient.

It should be noted that in Embodiment 1 described above, the MEMS switches 29 and 30 which are located close to the terminations of the lines 11 and 12 are driven by the lower drive voltage, and the MEMS switches 21 and 22 which are located close to the input ends of the lines 11 and 12 are driven by the higher drive voltage. Conversely, the MEMS switches 29 and 30 which are located close to the terminations of the lines 11 and 12 may be driven by the higher drive voltage, and the MEMS switches 21 and 22 which are located close to the input ends of the lines 11 and 12 may be driven by the lower drive voltage.

### EMBODIMENT 2

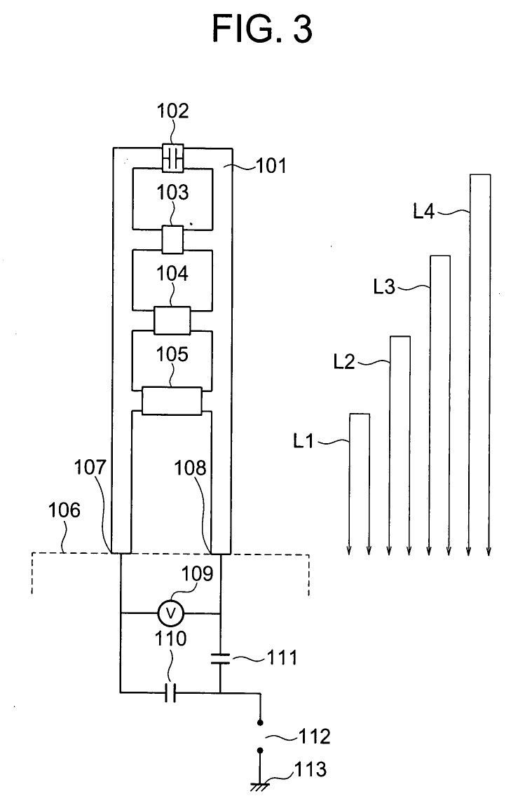

An antenna circuit according to Embodiment 2 of the present invention will now be described with reference to FIG. 3. FIG. 3 is a diagram for showing a configuration of the antenna circuit according to Embodiment 2 of the present invention.

In FIG. 3, the antenna circuit according to Embodiment 2 is provided with: an antenna 101, which is constituted by one set of comb-shaped conductor; a capacitor 102, which is sandwiched between comb teeth being a tip portion of the antenna 101; an MEMS switch 103, which is sandwiched between second comb teeth from the tip portion of the antenna 101, and has a large capacitance when a voltage applied to both ends of the MEMS switch 103 is equal to or higher than V1; an MEMS switch 104, which is sandwiched between third comb teeth from the tip portion of the antenna 101, and has a large capacitance when a voltage applied to both ends of the MEMS switch 104 is equal to or higher than V2; an MEMS switch 105, which is loaded between fourth comb teeth from the tip portion of the antenna 101, and has a large capacitance when a voltage applied to both ends of the MEMS switch 105 is equal to or higher than V3; and a voltage source 109, which drives the MEMS switches 103 to 105 between feeding points 107 and 108.

The antenna 101 is entered from the feeding points 107 and 108 to a lower plane of the ground 106, and is connected via the capacitors 110 and 111 to a wave source 112. The ground 113 of this wave source 112 has the same potential as that of the ground 106.

Next, operations of the antenna circuit according to Embodiment 2 will now be described with reference to the figure. It should be noted that as to voltages, a relationship of 0 (volt)<V1<V2<V3 is established, and as to lengths, a relationship of 0<L1<L2<L3<L4 is established.

When a voltage of the voltage source 109 is lower than V1, all of the MEMS switches 103, 104, and 105 have small capacitances, through which a radio frequency signal cannot pass. As a consequence, the antenna 101 is connected by the capacitor 102 at the tip portion thereof, and is operated at a frequency which is approximated to a ½ wavelength of the length L4.

When the voltage of the voltage source 109 is equal to or higher than V1 and lower than V2, the MEMS switch 103 has a large capacitance, through which a radio frequency signal can pass. As a consequence, the antenna 101 is connected by the MEMS switch 103 and is operated at a frequency which is approximated to a ½ wavelength of the length L3.

When the voltage of the voltage source 109 is equal to or higher than V2 and lower than V3, the MEMS switch 104 has a large capacitance, through which a radio frequency signal can pass. As a consequence, the antenna 101 is connected by the MEMS switch 104, and is operated at a frequency which is approximated to a ½ wavelength of the length L2.

When the voltage of the voltage source 109 is more than V3, the MEMS switch 105 has a large capacitance, through which a radio frequency signal can pass. As a consequence, the antenna 101 is connected by the MEMS switch 105, and is operated at a frequency which is approximated to a ½ wavelength of the length L1.

It should be noted that since the MEMS switches 103 to 105 have the capacitances, those MEMS switches may also be referred to as MEMS capacitors 103 to 105. As a consequence, the operations of Embodiment 2 may be described as follows. That is, the drive voltage of the MEMS capacitor 103 having the small capacitance is made low, whereas the drive voltage of the MEMS capacitor 105 having the large capacitance is made high. Also, in an actual operation, the drive voltage of the MEMS capacitor 103 having the small capacitance may be made high, whereas the drive voltage of the MEMS capacitor 105 having the large capacitance may be made low.

### EMBODIMENT 3

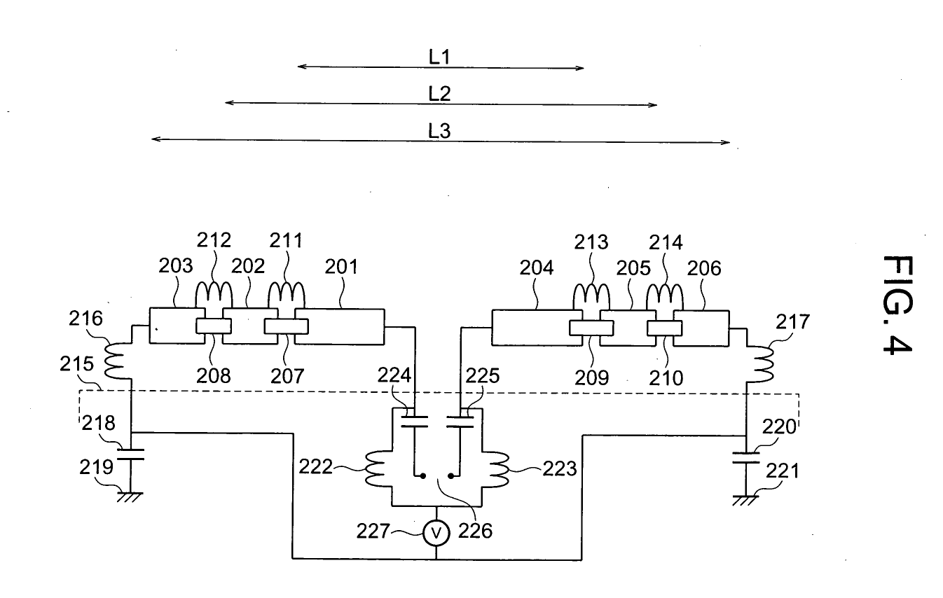

An antenna circuit according to Embodiment 3 of the present invention will now be described with reference to FIG. 4. FIG. 4 is a diagram for showing a configuration of the antenna circuit according to Embodiment 3 of the present invention.

In FIG. 4, the antenna circuit according to Embodiment 3 is provided with: an antenna including antenna conductors 201, 202, 203, 204, 205, and 206; an MEMS switch 207 provided between the antenna conductors 201 and 202; an MEMS switch 208 provided between the antenna conductors 202 and 203; an MEMS switch 209 provided between the antenna conductors 204 and 205; an MEMS switch 210 provided between the antenna conductors 205 and 206; a coil 211 provided between the antenna conductors 201 and 202; a coil 212 provided between the antenna conductors 202 and 203; a coil 213 provided between the antenna conductors 204 and 205; a coil 214 provided between the antenna conductors 205 and 206; a coil 216 connected to the outermost side of the antenna conductor 203; and a coil 217 connected to the outermost side of the antenna conductor 206.

The antenna conductors 201, 202, and 203 constitute one conductor of the antenna and are made of separate conductors. Also, the antenna conductors 204, 205, and 206 constitute the other conductor of the antenna and are made of separate conductors.

A housing 215 contains: a capacitor 218, one end of which is connected to the coil 216 and another end of which is connected to a ground portion 219; a capacitor 220, one end of which is connected to the coil 217 and another end of which is connected to a ground portion 221; a coil 222, which is connected to the innermost side of the antenna conductor 201; a coil 223, which is connected to the innermost side of the antenna conductor 204; a voltage source 227, which applies a DC voltage between the coils 222 and 223, and between the coils 216 and 217; a capacitor 224, which is connected between the innermost side of the antenna conductor 201 and a radio frequency signal input/output terminal 226; and a capacitor 225, which is connected between the innermost side of the antenna conductor 204 and the radio frequency signal input/output terminal 226.

Next, operations of the antenna circuit according to Embodiment 3 will now be described with reference to the figure. It should be noted that as to voltages, a relationship of 0 (volt)<V1<V2 is established. As to lengths, a relationship of 0<L1<L2<L3 is established.

Each of the MEMS switches 207 and 209 is designed in such a manner that when a voltage between both ends thereof is equal to or higher than V1, the MEMS switch is brought into a connection condition, whereas when a voltage between both ends thereof is lower than V1, the MEMS switch is brought into an open condition. Further, each of the MEMS switches 208 and 210 is designed in such a manner that when a voltage between both ends thereof is equal to or higher than V2, the MEMS switch is brought into a connection condition, whereas when a voltage between both ends thereof is lower than V2, the MEMS switch is brought into an open condition.

When the voltage of the voltage source 227 is equal to or higher than V2, all of the MEMS switches 207, 208, 209, and 210 are in the connection condition. The antenna circuit is configured by two conductors, namely, one conductor to which the antenna conductors 201, 202, and 203 are connected, and another conductor to which the antenna conductors 204, 205, and 206 are connected. The antenna circuit is operated as a dipole antenna having a length of L3. Because all of those coils represent large resistances with respect to a radio frequency signal, the radio frequency signal cannot pass through all of those coils. Also, capacitance values of all of those capacitors are selected to be such values that a DC bias cannot pass through those capacitors.

When a voltage of the voltage source 227 is equal to or higher than V1 and is lower than V2, the MEMS switches 207 and are in the connection condition, whereas the MEMS switches 208 and 210 are in the open condition. The antenna circuit is configured by two conductors, namely, one conductor to which the antenna conductors 201 and 202 are connected, and another conductor to which the antenna conductors 204 and 205 are connected. The antenna circuit is operated as a dipole antenna having a length of L2.

When a voltage of the voltage source 227 is lower than V1, all of the MEMS switches 207, 208, 209, and 210 are in the open condition. The antenna circuit is configured by two conductors, namely, the antenna conductor 201 and the antenna conductor 204. The antenna circuit is operated as a dipole antenna having a length of L1.

1. A switch circuit, comprising:
a plurality of MEMS switches which are connected parallel to each other, and whose drive voltages are different from each other; and
a single voltage source for driving the plurality of MEMS switches based upon a plurality of drive voltages.

2. A switch circuit according to claim 1, wherein:
the plurality of MEMS switches are arranged in a midst of a line having a predetermined length, respectively; and
the voltage source drives an MEMS switch located closer to a termination of the line at a lower drive voltage, and drives an MEMS switch located closer to an input end of the line at a higher drive voltage.

3. A switch circuit according to claim 1, wherein:
the plurality of MEMS switches are arranged in a midst of a line having a predetermined length, respectively; and
the voltage source drives an MEMS switch located closer to a termination of the line at a higher drive voltage, and drives an MEMS switch located closer to an input end of the line at a lower drive voltage.

4. A switch circuit according to claim 1, wherein:
the plurality of MEMS switches are sandwiched between comb teeth of a pair of comb-shaped conductors each having the plurality of comb teeth, respectively; and
the voltage source drives an MEMS switch located closer to a tip portion of the comb-shaped conductor at a lower drive voltage, and drives an MEMS switch located closer to a feeding point of the comb-shaped conductor at a higher drive voltage.

5. A switch circuit according to claim 1, wherein:
the plurality of MEMS switches are sandwiched between comb teeth of a pair of comb-shaped conductors each having the plurality of comb teeth, respectively; and
the voltage source drives an MEMS switch located closer to a tip portion of the comb-shaped conductor at a higher drive voltage, and drives an MEMS switch located closer to a feeding point of the comb-shaped conductor at a lower drive voltage.

6. A switch circuit, comprising:
a plurality of MEMS switches which are connected in series, and whose drive voltages are different from each other; and
a single voltage source for driving the plurality of MEMS switches based upon a plurality of drive voltages.

7. A switch circuit according to claim 6, wherein:
the plurality of MEMS switches are arranged between conductors so that the MEMS switches connect the plurality of conductors to each other; and
the voltage source drives the plurality of conductors connected in series by the plurality of MEMS switches at a lower drive voltage, in a case of shortening the plurality of conductors connected in series by the plurality of MEMS switches, and drives the plurality of conductors connected in series by the plurality of MEMS switches at a higher drive voltage, in a case of elongating the plurality of conductors connected in series by the plurality of MEMS switches.
